(19) United States
(12) Patent Application Publication
(10) Pub. No.: US 2005/0031234 A1
(43) Pub. Date: Feb. 10, 2005

(54) Cutting machine having crosshead having bearings

(76) Inventor: Thomas O. Orszagh, Lakeview, NY (US)

Correspondence Address: John M. Del Vecchio;Hodgson Russ LLP, Suite 2000, One M&T Plaza, Buffalo, NY, 14203-2391, US

(21) Appl. No.: 10/831,215

(22) Filed: Apr. 23, 2004

Related U.S. Application Data
(60) Provisional application No. 60/466,714, filed on Apr. 30, 2003.
(60) Provisional application No. 60/492,895, filed on Aug. 6, 2003.

(51) Int. Cl. F16C 29/04

(52) U.S. Cl. 384/49

(57) ABSTRACT

A cutting machine having guides and comprising a crosshead with bearings wherein the bearings are used for guiding the crosshead as it reciprocates between the guides without the use of added lubricants. The bearings comprise ball bearings or bearing inserts. A body comprising a first member defining first member pin holes and a second member defining second member pin holes, and a connecting member used for connecting the first member to the second member, the first member and second member defining ball bearing recesses therebetween. Ball bearings received in each of the ball bearing recesses with the pins positioned through the first pin holes and second pin holes and used for securing the ball bearings in the ball bearing recesses. The ball bearings used for rolling over the guides. In another embodiment the crosshead comprises a body having sides and defining bearing component recesses in the sides. A pair of guides each having inwardly sloping walls that meet define V-shaped recesses. Bearing components comprising insertion portions are sized to be received in the bearing component recesses defined in the crosshead body. The bearing components are connected to the bearing component recesses by an epoxy and wherein the bearing components further comprise contact sides that are at an angle to one another and are used for being received in the V-shaped recesses defined in the guides. The bearing components are of a polyimide or high strength plastic. The use of added lubricants is eliminated between the guides and crosshead.

### CROSS REFERENCE TO RELATED APPLICATIONS

This application claims the benefit of Provisional U.S. Patent Application No. 60/466,714 to Orszagh and filed on Apr. 30, 2003, for a “Cutting Machine Having Crosshead With Ball Bearings.” This application also claims the benefit of Provisional U.S. Patent Application No. 60/492,895 to Orszagh and filed on Aug. 6, 2003, for a “Cutting Machine Having Crosshead With Non-Metallic Wear Surface.”

### FIELD OF INVENTION

The present invention relates to cutting machines having a motor assembly and a connecting rod used for reciprocating a crosshead between guides without the use of a lubricant between the crosshead and guides.

### BACKGROUND

The present invention relates generally to cutting machines such as for cutting cloth, as exemplified by U.S. Pat. No. 3,960,244 to Clark; U.S. Pat. No. 3,775,913 to Clark; U.S. Pat. No. 3,714,742 to Clark; and U.S. Pat. No. 5,178,232 to Bennett et al., which patents are assigned to the assignee of the present invention. More particularly, the present invention relates to a cutting machine having a crosshead for reciprocating a knife or blade.

In cloth cutting machines having reciprocatory knives, it is necessary to convert the rotary motion of an electric motor to the reciprocating motion of the cutting knife. To accomplish this the motor is provided with a crank pin, and this crank pin rotates as the motor rotates. One end of a connecting rod is journalled to the crank pin, and the other end of the connecting rod is journalled to a wrist pin. The wrist pin in turn is connected to a crosshead. Thus, as the motor rotates, the crank pin rotates causing the connecting rod to reciprocate, and this causes the crosshead to reciprocate between the guides. Also, as the motor rotates a knife, which is connected to the crosshead, is also caused to reciprocate so that it can cut cloth. It has been an important feature of such machines to provide lubrication of the crosshead-guide area, and to provide lubrication of the wrist pin-crosshead connection. Such lubrication has been effected through a lubricant reservoir positioned above the crosshead and through a wick means in the lubricant reservoir for conducting lubricant to the wrist pin and guide areas. One arrangement of the wicks is shown in FIG. 3 of the '244 patent, and another in the '232 patent. Various other arrangements of the wicks in the wicking block of such machines have been employed to eliminate void spaces within the block which cause lubricant pooling.

The use of one cloth cutting machine is illustrated in the '913 patent. The machine includes a base having rollers which roll on a table top supporting the layer of material to be cut. As the machine is moved over the table top and guided for cutting of the cloth by an operator, the operator grasps the machine by a handle, and a knife is reciprocated to cut the cloth.

However, because the cloth cutting machine is portable, it may from time to time be laid on its side or turned upside down, with the undesirable result that an externally positioned oil cup can be damaged or oil can leak from the knife guidance system. Furthermore, such machines require downtime for the periodic addition of oil, cleaning, and maintenance. This decreases productivity. Moreover, if too much oil is provided, heat build-up may result due to the increased viscous friction as the crosshead reciprocates between the guides. Thus, there is a need for a crosshead that can be used in these cloth cutting machines but does not require the above-described lubricants in the guide areas and the wrist pin areas.

Thus, one of the objectives of the present invention is to provide a cloth cutting machine comprising a means for converting the rotary motion of an electric motor to the reciprocating motion required by a crosshead and knife, without the use of lubricants and oil cups. It would also be desirable if the cutting machine were to have a long working life, was easy to maintain, and was inexpensive to keep in operation.

### SUMMARY

The cutting machine comprises a crosshead having bearings. In particular, the cutting machine has a housing and guides are fastened to the housing. The crosshead is positioned between the guides. A motor is provided for in the housing and a connecting rod connects the motor and crosshead. When the motor is activated and rotates the connecting rod causes the crosshead to reciprocate between the guides. Bearings are used between the guides and crosshead so that the crosshead can be reciprocated without having to add lubricants between the guides and crosshead.

The crosshead comprises a body comprising a first member defining first member pin holes and a second member defining second member pin holes. A connecting member is provided and used for connecting the first member to the second member, and the first member and second member define ball bearing recesses therebetween. Ball bearings are received in each of the ball bearing recesses, and pins are positioned through the first pin holes and second pin holes and used for securing the ball bearings in the ball bearing recesses. The ball bearings roll over the contact surface of the guides. A guide engaging portion of the ball bearings extends past the sides of the crosshead body.

The crosshead also has a wrist pin housing used for receiving a wrist pin therein. A first end of the connecting rod is journalled to the crank extending from the motor, and a second end of the connecting rod is journalled to a wrist pin received in the wrist pin housing. The connecting rod reciprocates the crosshead when the motor is activated. The body also has a blade side and has a tab extending from the blade side. The tab defines a bolt hole and is for receiving a bolt so that the cutting machine knife can be bolted thereto. Thus, when the crosshead reciprocates the blade reciprocates.

Shims are provided and bolted to the guides. As the crosshead reciprocates it wears against the shims so that the more expensive guides are not worn. When the shims wear out they are unbolted from the guides and replaced. It is noted that travel recesses are defined between the contact surface of the guides, shims, and extension portions of the guides. The travel recesses are used for allowing the guide engaging portions of the ball bearings to reciprocate back and forth therein.

In another embodiment the crosshead comprises a body having sides defining side recesses. Bearing components are provided that have insertion portions which are received in the recesses and bonded to the surrounding will that defines the recesses. An epoxy can be used as the bonding agent. The bearing components also have contact surfaces that are at an angle to one another and are used for contacting and sliding across the cutting machine guides. The bearing components comprise can Vespel®, which is commercially available from E.I. du Pont de Nemours and Company, Wilmington, Delaware, and Vespel® is well known to those having ordinary skill in the art. The bearing components can also be made of polyimide materials and high performance plastics.

Guides are provided and bolted to the cutting machine. The guides have inwardly sloping walls that define V-shaped recesses in the guide. The V-shaped recesses extend along the lengths of each guide. The bearing components are used for being received in the V-shaped recesses defined in the guides, such that the contact surfaces of the bearing components wear against the inwardly sloping walls in the guides when the crosshead is reciprocated by the cutting machine.

The crosshead has a body which defines hole and a wrist pin sleeve is fitted in the hole. A bushing is fitted into the sleeve and the wrist pin fits into the wrist pin bushing. A connecting rod connects the wrist pin to the crank pin of the cutting machine. No lubrication is required between the wrist pin bushing and sleeve and because the wrist pin bushing is made of Vespel®, a polyimide materials, or a high performance plastic. The need for lubrication between the crosshead and the guides and in the wrist pin bushing has thus been eliminated.

Thus, by the use of bearings such as ball bearings and bearing components, the need to add lubricants to between the guides and crossheads in cutting machines has been eliminated.

### BRIEF DESCRIPTION OF THE DRAWINGS

This invention is illustrated in the drawings in which like reference numbers designate the same or similar parts.

FIG. 1 shows a front elevational view of the cutting machine.

FIG. 2 shows a perspective view of the cutting machine housing.

FIG. 3 shows a front perspective view of the crosshead between guides.

FIG. 4 shows a top plan view of the crosshead and guides.

FIG. 5 shows a front elevational view of the shim for use with the left guide.

FIG. 5A shows a front elevational view of the shim for use with the right guide.

FIG. 6 shows a front elevational view of the left hand guide.

FIG. 7 shows a front elevational view of the right hand guide.

FIG. 8 shows a perspective view of the crosshead body without the bearings connected thereto.

FIG. 8A shows a front elevational view of the crosshead body without bearings.

FIG. 8B shows a front elevational view of the crosshead body with bearings.

FIG. 9 is a front elevation view of the second embodiment of the crosshead and cutting machine.

FIG. 10 is a perspective view of the second embodiment of the crosshead positioned between guides.

FIG. 11 is a front elevational view of the second embodiment of the crosshead.

FIG. 12 is a right side elevational view of the second embodiment of the crosshead.

FIG. 13 is a bottom plan view of the second embodiment of the crosshead.

FIG. 14 is an exploded view of the second embodiment of the crosshead.

FIG. 15 is a front elevational view of a bearing component.

FIG. 16 is a left side elevational view of the bearing component

### DETAILED DESCRIPTION

In the cutting machine 100 of the present invention, problematic lubricants are not used. Rather, bearings 8 are used for guiding and reducing friction. In particular, bearings 8 are used between the guides connected to the cutting machine and the reciprocating crosshead positioned between the guides. The bearings 8 thus eliminate the need for added lubricants between the guides and crosshead.

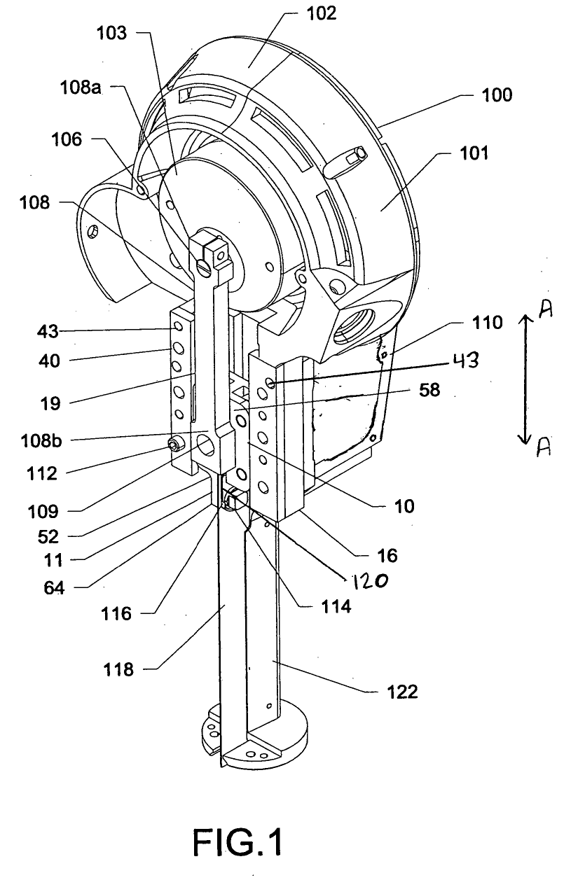

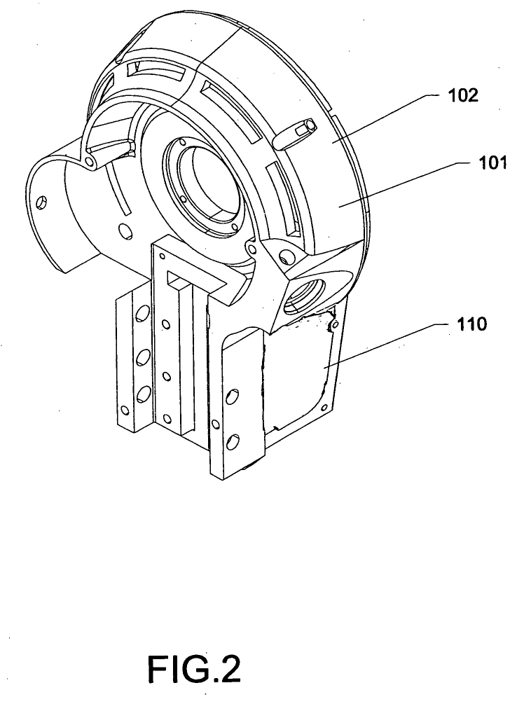

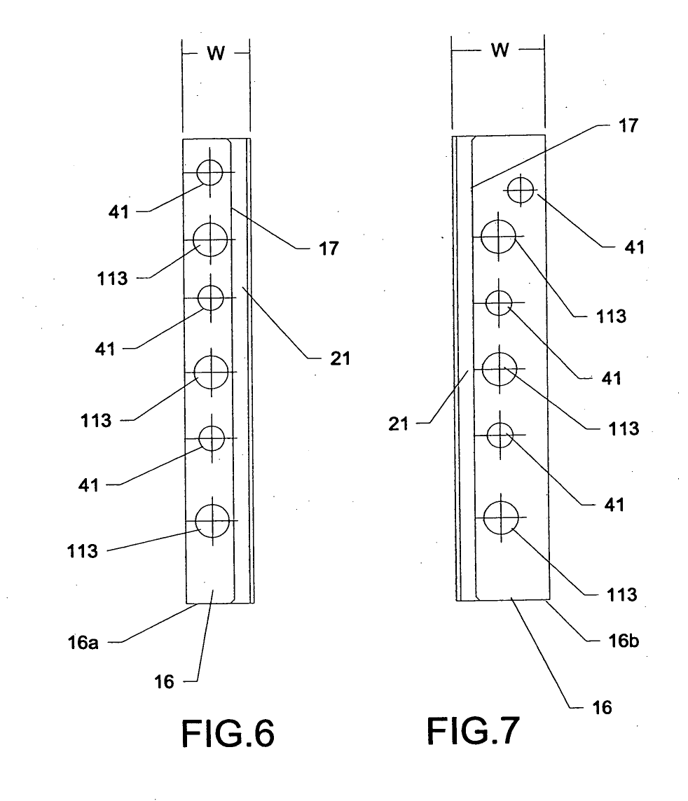

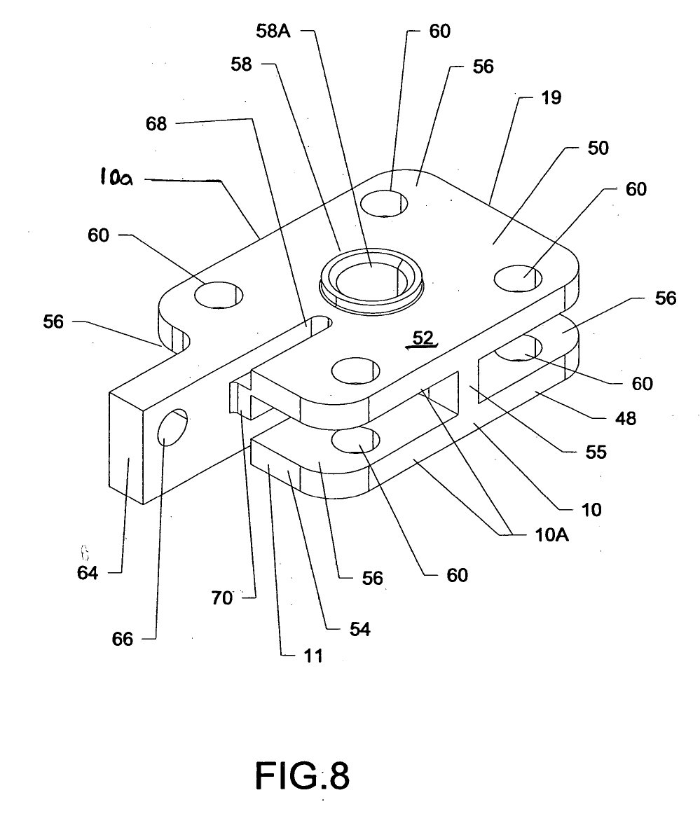

As shown in FIGS. 1, 3, 4, 6, 7, and 8B, the cutting machine 100 has a crosshead 10 having bearings 8. The crosshead 10 allows the rotary motion from an electric motor 103 to be converted to the reciprocating motion required for cutting cloth with a cloth-cutting knife/blade 118, without the use of lubricants. The bearings 8 are ball bearings 20 having inner and outer races, ball bearings are well known to those having ordinary skill in the art. The ball bearings 20 reciprocate between guides 16 that include a left hand guide 16a and a right hand guide 16b. The guides 16 are connected with bolts 112 to the lower housing portion 110 of the cutting machine housing 101. A perspective view of the cutting machine housing 101 is shown in FIG. 2. The cutting machine 100 housing 101 has a front bearing housing 102 and a lower housing portion 110 connected thereto, and an electric motor 103 is supported in the front bearing housing 102. It is noted that cutting machine motors 103 and bearing housings 102 for the motors 103 are well known to those having ordinary skill in the art. A first end 108a of a link or connecting rod 108 is journalled to the crank pin 106 extending from the motor 103, as shown in FIG. 1. The second end 108b of the connecting rod 108 is journalled to the wrist pin 109, and the wrist pin 109 is received in the wrist pin housing 58 formed in the crosshead 10. The crosshead 10 is positioned between the guides 16. The guides 16 are secured to the lower housing portion 110 by means of guide washers and hold-down screws or bolts 112 threaded to internally threaded guide bolt recesses 113 (FIGS. 6 and 7) and into the housing lower portion 110. A lock bolt 114 and a lock washer 116 connect a knife or blade 118 to a lower portion or tab 64 formed at the knife end 11 of crosshead 10, as shown in FIG. 1. The knife 118 is positioned in a guide defined by a knife slide 120 within a knife standard 122, all of which extends in a direction away from the motor 103 and toward the workpiece (not shown) of cloth or other material to be cut. The cutting machine 100 thus reciprocates the crosshead 10 between the guides 16 when the motor 103 is activated and spins the crank pin 106. Also, through the above-described linkage, the blade or knife 118 is caused to reciprocate while the motor 103 is activated.

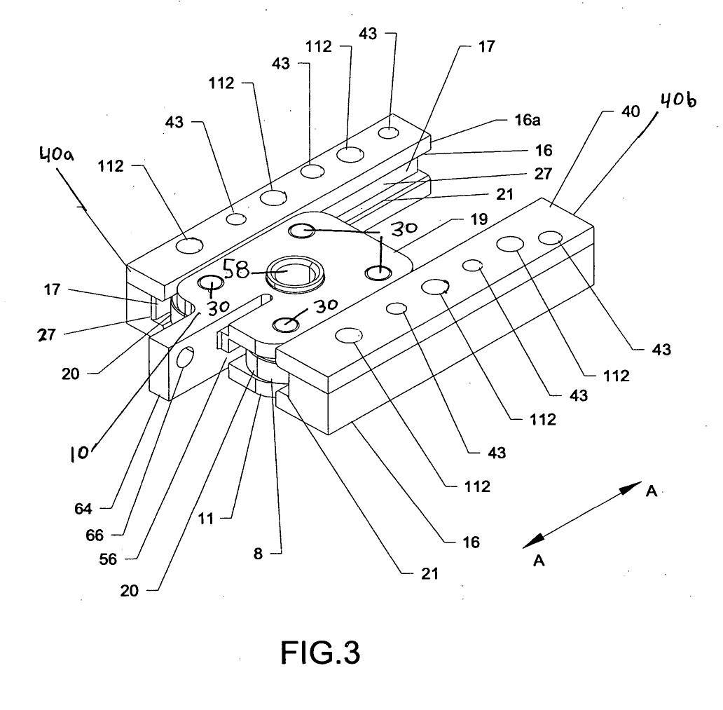

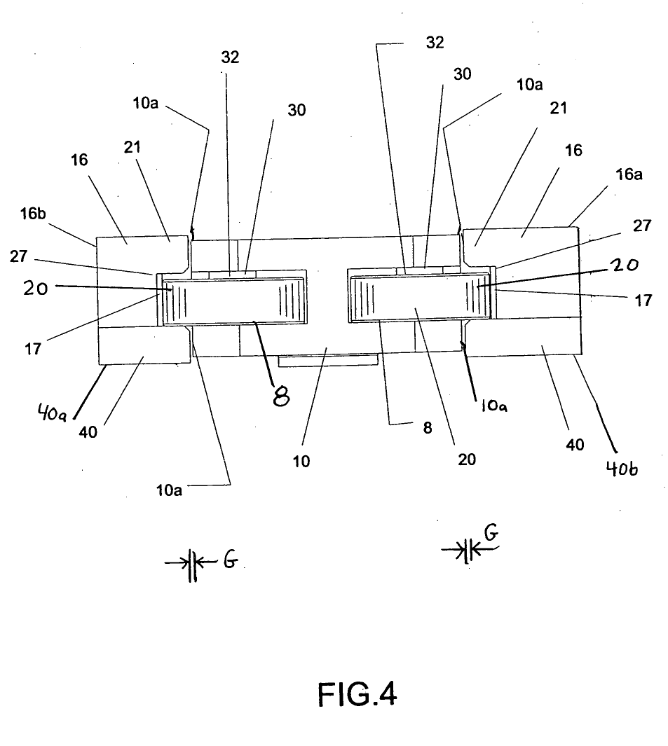

FIG. 3 shows a perspective view of the crosshead 10 positioned between the left guide 16a and right guide 16b. Front elevational views of the guides 16 and in particular the left guide 16a and right guide 16b are shown in FIGS. 6 and 7. It is noted that the left guide 16a and right guide 16b each have a rolling surface 17 and an extension portion 21. The ball bearings 20 of the crosshead 10 roll across these rolling surfaces 17 in a manner to be described presently. The extension portion 21 of each guide 16a, 16b, respectively, assists in guiding the ball bearings 20. Also shown in FIG. 3 are the shims 40 connected to the left and right guides 16a, 16b, respectively, which will be described in greater detail presently. FIG. 4 shows a top plan view of the crosshead 10 shown in FIG. 3, further detailing the left and right guides 16a, 16b, respectively, shims 40, and ball bearings 20.

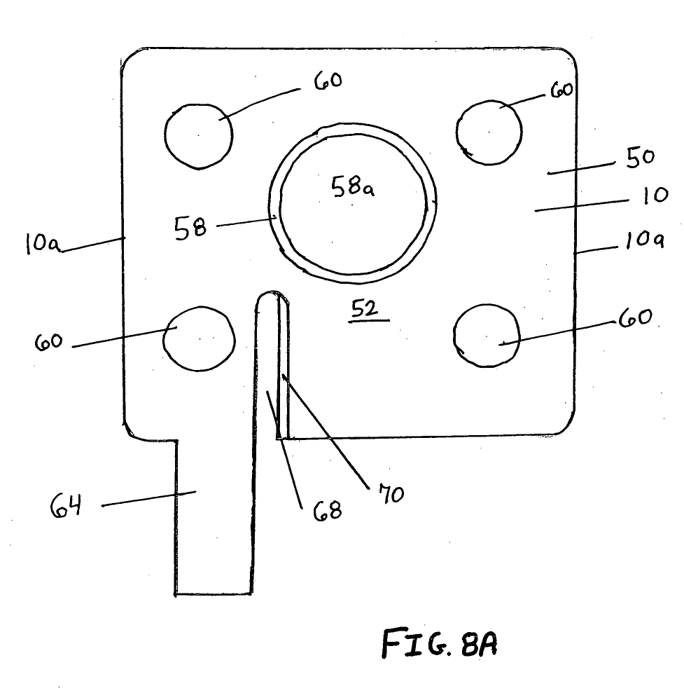

Turning now to the crosshead 10, the crosshead 10 is shown in greater detail in FIGS. 8-8B. FIG. 8 shows a perspective view of the crosshead 10. The crosshead 10 has a connecting rod end 19 and knife or blade end 11. The crosshead 10 comprises a body 50 having sides 10a, and a first member 52 and a second member 54 connected to one another by a connecting member 55. The body 50 defines four ball bearing recesses 56 each used for the receiving a ball bearing 20 therein. The body 50 also comprises a wrist pin housing 58 that extends from a position elevated with respect to the first member 52 completely through the body 50. The wrist pin housing 58 thus defines a wrist pin recess 58a in body 50. The wrist pin housing 58 is used for receiving the wrist pin 109 therein so that the crosshead 10 can be connected to the connecting rod 108, in the manner previously described. The body 50 defines dowel or pin holes 60 that extend through the first and second members 52, 54, respectively and which are used for receiving a dowel or pin 30. The body 50 further comprises a lower portion or tab 64 that extends from the blade end 11 of the body 50 and which defines a bolt hole 66. The bolt hole 66 is used for receiving the lock bolt 114 and lock washer 116 to secure the knife blade 118 to the tab 64 of the crosshead 10. The body 50 defines a slot 68 that extends through the first and second members 52,54, respectively. The slot 68 is used for receiving an end of the knife 118 therein. The first member 52 further comprises a ledge 70 that is used for guiding the knife 118 when it is being installed or removed from the crosshead 10. It is noted that the connecting member 55 separates the first and second members 52,54, respectfully so that the ball bearings 20 can be received in the ball bearing recesses 56. The body 50 can be formed by machining and by casting processes, or by combinations thereof by methods well known to those having ordinary skill in the art. The crosshead 10 can be of metal, aluminum, metal alloys, plastics, metal alloys, and combinations thereof.

FIG. 8A shows a front elevational view of the body 50, and FIG. 8B shows a front elevational view of the crosshead 10 with the ball bearings 20 installed. The ball bearings 20 are mounted on a pin or dowel 30. Spacers 32 are used between the ball bearings 20 and the crosshead 10, such that each side of each ball bearing 20 contacts a spacer 32, as shown in the top plan view of FIGS. 4. The ball bearings 20 are of the type that are pre-lubricated and sealed prior to installation in the crosshead 10. Pre-lubricated sealed ball bearings known to those having ordinary skill in the art. As shown in FIGS. 3 and 8B a portion of the ball bearings 20 extend past the sides 10a of the crosshead 10. These portions of the ball bearings 20 travel through travel recesses 27 as the crosshead 10 reciprocates and contact the contact side 17 of the guides 16. In particular, the travel recesses 27 for the ball bearings 20 are defined by the contact side 17 of the guides 16, the shims 40, and the extension portions 21 of the guides 16. Thus, the crosshead 10 is kept in the travel recesses 27 as it is reciprocated.

Assembly of the crosshead 10 is carried out by positioning the spacer 32 on either side of a bearing 20 and moving the bearing 20 into a bearing recess 56. Then the pin or dowel 30 is moved through the pin holes 60 in the first and second members 52,54, respectively, and secured therein, for example by friction fit. The guides 16, which define guide bolt holes 113 are used for receiving guide bolts 112 therein, are bolted to the lower housing portion 110. The connecting rod 108 is connected to the crosshead 10 when the crosshead 10 is between the guides the left guide 16a and right guide 16b. This is accomplished by taking the wrist pin 109 and positioning it in the wrist pin housing 58, and journalling the second end of the connecting rod 108b to the wrist pin 58, and journalling the first end of the connecting rod 108a to the crank pin 106. The crosshead 10 and motor 103 are thus connected by the link or connecting rod 108.

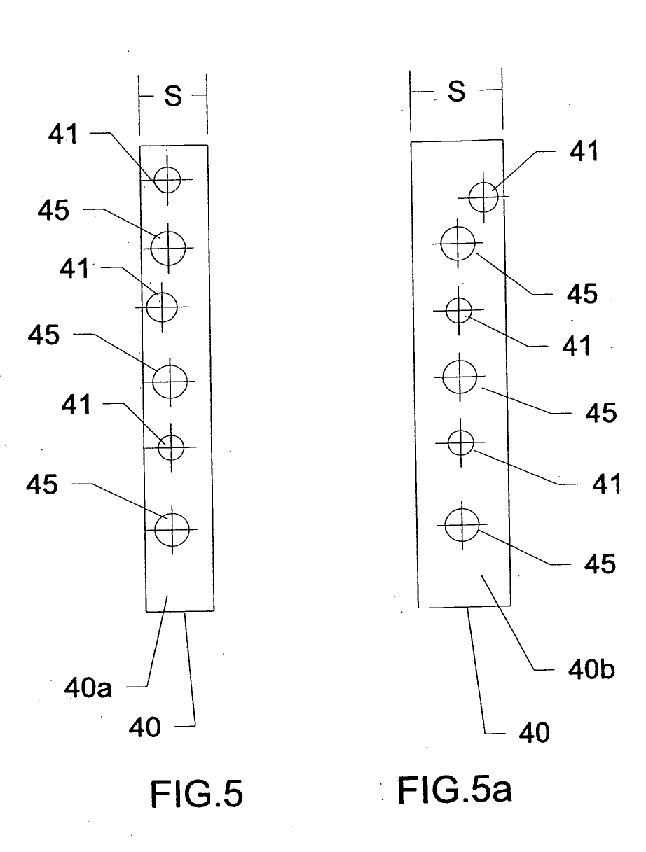

Next, the shims 40, which comprise a left shim 40a and right shim 40b as shown in FIGS. 5 and 5A, are bolted to the guides 16. Each shim 40 has shim holes 41 and shim bolts 43 are provided as shown. The shims 40 also define guide bolt holes 45 for receiving the guide bolts 112 therethrough. The shims 40 are attached to the guides by the shim bolts 43 being threaded through the shim 40 and into the guides 16. Thus, in this manner the shims 40 and guides 16 are connected to one another and the housing lower portion 110.

The shims 40 have a width designated S in FIGS. 5 and 5A, and the guides 16 each have width designated W, as shown in FIGS. 6 and 7. The width S of the shim 40 is greater than the width W of the guides 16 so that when the shims 40 are bolted to the guides 16, as described above, the sides 10a of the crosshead 10 are closer to the shims 40 than the guides 16. Therefore, the crosshead 10 wears against the less expensive shims 40 instead of the more expensive left and right guides 16a, 16b, respectively, as it is reciprocated. As shown in the top plan view of FIG. 4, the shims 40 wear against the crosshead sides 10a, while the ball bearings move across contact surface 17, since there is a gap distance, designated G in FIG. 4, between the guides 16 crosshead 10. As shown, the more expensive guides 16 are not contacted by the crosshead sides 10a and are not worn as the crosshead 10 reciprocates. Thus, the shims 40, which are relatively inexpensive when compared to the cost of the guides 16, are used for a sacrificial wear surface and/or material. This in turn preserves the working lifespan of the guides 16. After the shims 40 wear out such that the crosshead sides 10a are about to contact the guides 16, the shims 40 are removed and new shims 40 are installed. This can be done quickly by unscrewing the shim bolts 43 and installing new shims 40. Additionally, because the shims 40 are replaced before the crosshead 10 wears out, the left and right guides 16a, 16b never have to be replaced because they are not worn.

The crosshead 10 is reciprocates in the direction indicated by the arrows A-A in FIGS. 1 and 3 when the motor 103 is activated. Thus, through the above described linkage, when the crank pin 106 turns the knife 118 is caused to reciprocate in the guide defined by the knife slide 120 within the knife standard 122, and because the crosshead 10 uses ball bearings 20 no added lubrication is required as the ball bearings 20 reciprocate in the travel recesses 27.

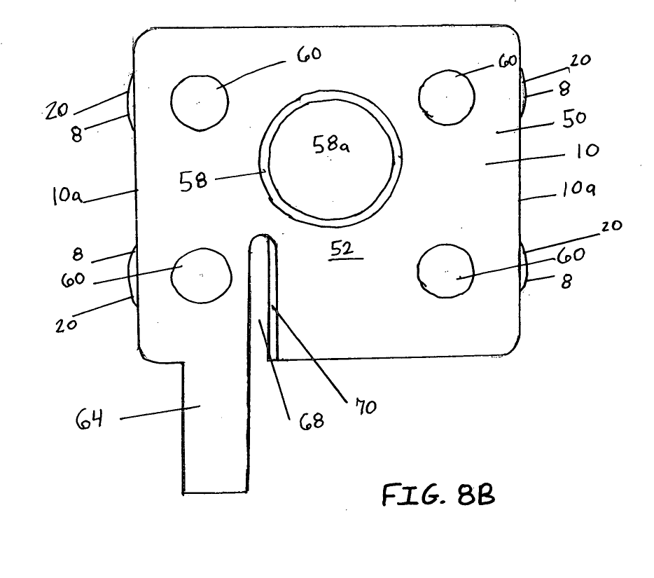

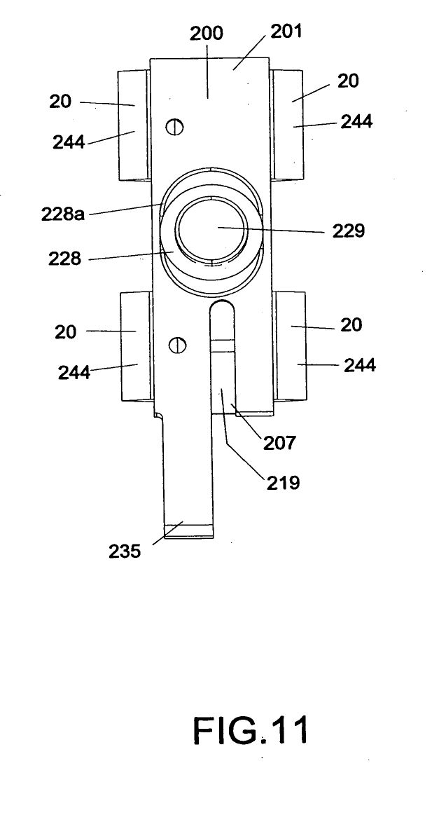

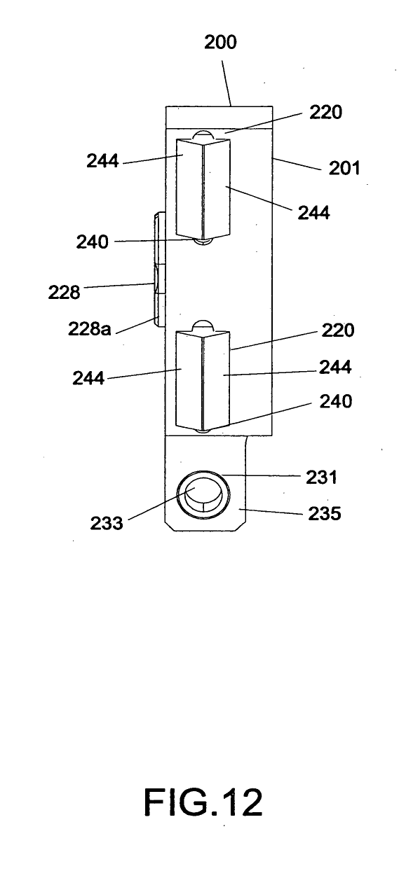

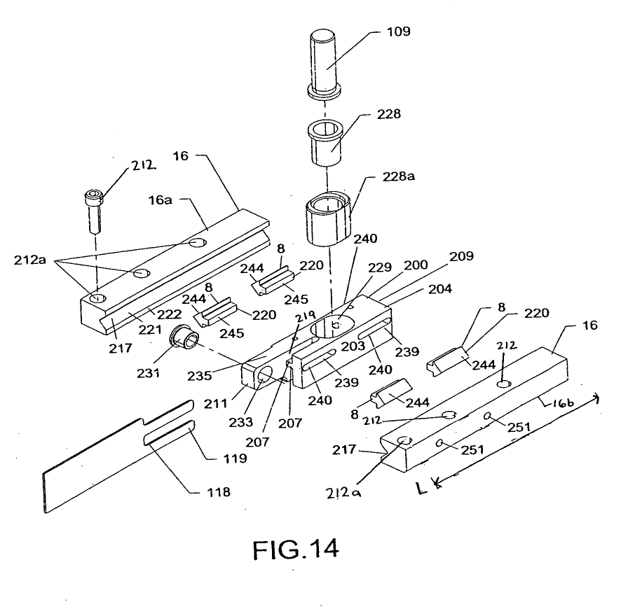

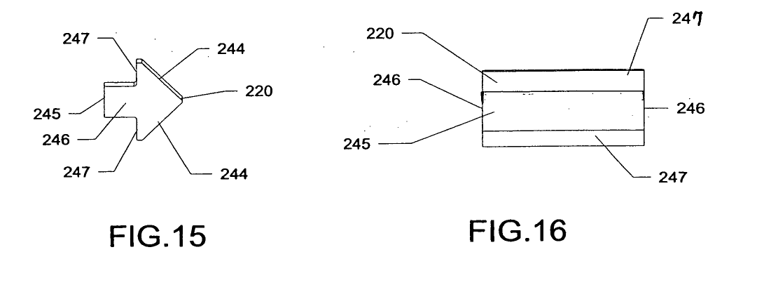

In another embodiment, shown in FIGS. 9-16, the cutting machine 100a is generally the same as the cutting machine 100 previously described, but the crosshead 200 and crosshead guides 216 are different. In this embodiment, bearings 8 that comprise bearing components 220 are used to eliminate the need for added lubricants between the crosshead 200 and guides 216, and no added lubricants are required between the wrist pin bushing 228 and wrist pin 109.

As shown in FIG. 9, 10, and 14, when the motor 103 is activated, it spins, causing the crank pin 106 to spin. A first end 108a of the link or connecting rod 108 is journalled to the crank pin 106. The second end 108b of the connecting rod 108 is journalled to the wrist pin 109, and the wrist pin 109 is received in the wrist pin bushing 228. The wrist pin bushing 228 is received in the wrist pin sleeve 228a. The wrist pin sleeve 228a is received in a wrist pin sleeve hole 229 defined in the crosshead 200 body 201. It is noted the wrist pin sleeve hole 229 is oval-shaped, which prevents the rotation of the wrist pin sleeve 228a in the wrist pin sleeve hole 229. The crosshead 200 is positioned between crosshead guides 216 which include a left hand crosshead guide 216a and a right hand crosshead guide 216b. The guides 216 are secured to the housing portion 110 by means of guide washers and hold-down screws or bolts 212. The hold-down screws 212 are threaded through hold-down screw recesses 212a defined in the crosshead guides 216. A suitable lock bolt and nut 114 and lock washer 116 secure the knife blade 118 to a lower portion or tab 235 extending from the body 201 of the crosshead 200. The knife 118 is located in a guide defined by a knife slide 120 within a knife standard 122, all of which extends in a direction away from the motor 103, as shown in FIG. 9. Through this linkage, the blade or knife 118 is caused to reciprocate when the motor 103 is activated.

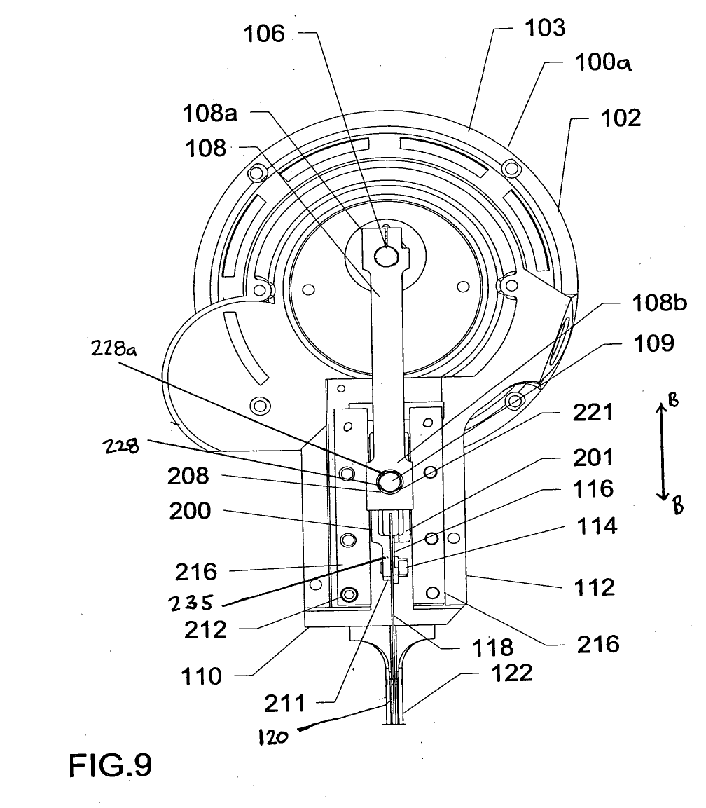

Turning now to FIGS. 10-16, the crosshead 200 provides a way to convert the rotary motion from the electric motor 103 to the reciprocating motion needed for cutting cloth with a cloth-cutting knife 118, without the use of added lubricants. The crosshead 200 is guided in its reciprocatory movement by guides 216 and in particular a left hand guide 16a and a right hand guide 16b. The crosshead 200 has bearings 8. The bearings 8 used in connection with this embodiment are bearing components 220. The bearing components 220 comprise Vespel®, which is commercially available from E.I. du Pont de Nemours and Company, Wilmington, Delaware, and Vespel® is well known to those having ordinary skill in the art. The bearing components 220 can also be made of polyimide materials and high performance plastics.

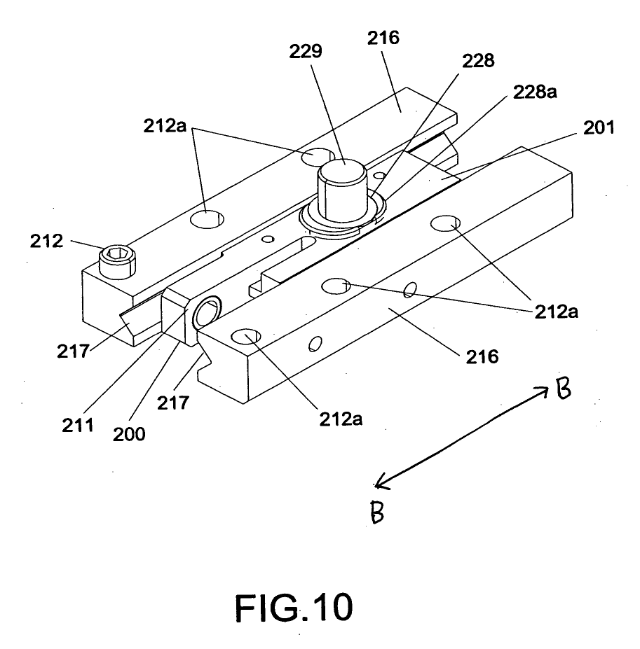

As shown in FIGS. 10 and 11, the crosshead 200 comprises a body 201 having a generally rectangular shape. The crosshead 200 defines a wrist pin sleeve hole 229 into which the wrist pin sleeve 228a and wrist pin bushing 228 are positioned. The wrist pin bushing 228 can comprise Vespel®, polyimide materials, or high performance plastics. The crosshead 200 is connected to the connecting rod 108 by the wrist pin 109. The wrist pin bushing 228 extends beyond the crosshead 200, as shown in FIG. 10. This allows the wrist pin bushing 228 and the second end 108b of the connecting rod or link 108 to be journalled to the wrist pin 109 (FIG. 9). Thus, in this manner, the crank pin 106, which is in rotational communication with the motor 103, is linked to the crosshead 200. The above-described linkage allows the crosshead 200 to be reciprocated as the motor 103 rotates and the crank pin 106 turns.

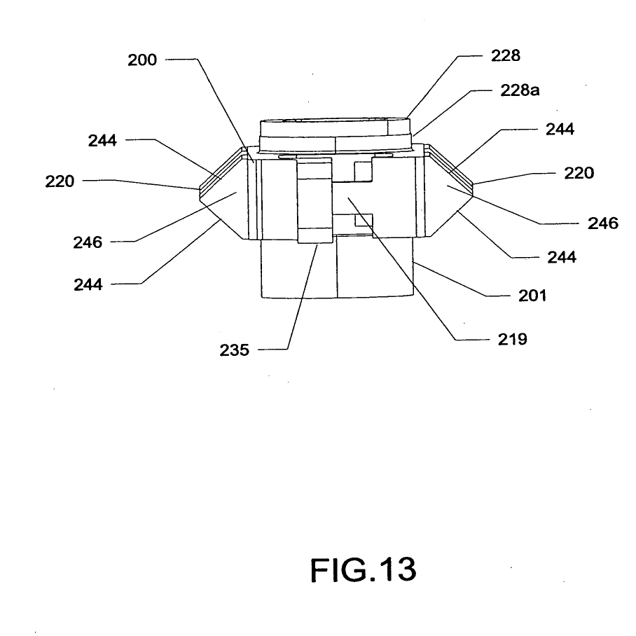

The crosshead 200 body 201 has body sides 203 and there are bearing component recesses 240 defined in the body sides 203 by recess surrounding walls 239, as shown in FIG. 14 at predetermined positions. The bearing component recesses 240 are sized to receive bearing components 220 therein in a manner to be described presently. The body further comprises a front side 204 a rear side 206, and a tab end 211 and an opposite connecting rod end 209.

As shown in FIGS. 14-16, each bearing component 220 has two guide contact sides 244 that are at an angle to one another, ends 246, and an insertion side 247 from which extends an insertion portion 245. As shown in FIGS. 14-16, the bearing component 220 is arrow-shaped. The guide contact sides 244 are used for being received in V-shaped recesses 217 defined in the guides 216 of the cutting machine 100a. In particular, each guide 216 has two inwardly sloping walls 221 that meet and define the V-shaped recess 217 in the guide 216. The inwardly sloping walls 221 provide guide contact surfaces 222 for the bearing components 220 to slide over, and in particular for the contact sides 244 of the bearing components 220 to slide over. Since the guides 216 can comprise steel or other metal and the bearing components 220 can comprise Vespel®, polyimide materials, or high performance plastics, when the crosshead 200 is reciprocated the contact surfaces 244 of the bearing components 220 provide a the crosshead 200 with nonmetallic wear surfaces.

The crosshead 200 also defines blade receiving slots 207 formed in the tab end 211 of the crosshead 200. The slots 207 are used for receiving an end of the knife or blade 118, as shown in FIG. 14. The knife blade 118 has a forked end 119 and is inserted into the blade receiving slots 207 such that knife slot wall 219 is positioned between the forks of the forked end 119. A threaded insert 231, which can comprise steel, is provided and secured in the tab hole 233 defined in a tab 235 extending from the crosshead 200. The nut and bolt 114 are received in the tab hole 233 and through a hole in the knife blade 118 and are used for connecting the knife blade 118 to the crosshead 200. The slots 207 are used for assisting in securing the knife 118 to the crosshead 200 and preventing the knife blade 118 from uncontrollably twisting as it is reciprocated.

To assemble the crosshead 200, the bearing component 220 insertion portion 245 is positioned in and adhered to the recess surrounding wall 239 that defines the bearing component recesses 240 in the crosshead 200 body 201. A two part epoxy, for example Ecobond 104® A/B in this particular embodiment which is commercially available from Emerson and Cuming, Inc., Canton, Mass., can be used to bond the bearing components 220 in the bearing component recesses 240. In other embodiments, different epoxies and bonding agents can be used, such bonding agents and epoxies are well known to those having ordinary skill in the art.

The wrist pin sleeve 228a, which that can comprise steel, is pressed into the wrist pin sleeve hole 229 in the crosshead body 201. The wrist pin bushing 228 is press fitted into the wrist pin sleeve 228a. The wrist pin 109, which can comprise steel, is fitted into the wrist pin bushing.

The assembled crosshead 200 is positioned between the a left hand guide 216a and a right hand guide 216b, as shown in FIGS. 10 and 14. The guides 216 are connected to the machine housing 110 by bolts 212 threaded in the bolt recesses 212a. As the cutting machine 100a reciprocates the bearing components 220 move back and forth in the V-shaped recesses 217 of the guides 216. The crosshead 200 reciprocates in the direction indicated by the arrows B-B in FIGS. 9 and 10 between the guides 216. In this manner the knife 118 is caused to reciprocate in a guide defined by a knife slide 120 within a knife standard 122 that is attached to the lower housing portion 110 of the cutting machine 100a. The crosshead 200 is guided in guides 216 and comprises bearing components 220 that do not require added lubricants and the wrist pin bushing 228 does not require added components.

Over time as the bearing components 220 wear down, the user has several options. The user can simply remove the crosshead 200 from the cutting machine 100a and install a new crosshead 200 in the cutting machine 100a. The user can also adjust the cutting machine 100a and move the guides 216 closer together by tightening the adjustment screws 251, which has the effect of drawing the guides 216 closer together. This moves the contact surfaces 244 of the bearing components 220 into closer proximity with the guide contact surfaces 222 of the guides 216. This has the thus extends the working life of the bearing components 220, since they can be repeatedly worn down as described above. This decreases costs.

The crosshead 210 may be formed by machining processes, or by casting processes, or by other processes known to those having ordinary skill in the art. The crosshead 210 can be of aluminum or aluminum alloys. The bearing components 220 may be formed by machining process, by casting process, or by other processes known to those having ordinary skill in the art. The bearing components 220 can comprise any grade of Vespel® although grade SP21 is preferred. Torlon® (registered mark of AMOCO Performance Products, Inc., Ridgefield, Conn.), or any other polyimide or polyamide plastic or variation of polyimide or polyamide plastic may also be used for the bearing components 220. Thus, the bearing component 220 provides for a non-metallic wear surface. The bearing components 220 can be chemically bonded with Ecobond 104® A/B (Emerson & Cuming, Inc., Canton, Mass.) or any similar two part epoxy to the recesses 240 as described above. Epoxies are well known to those having ordinary skill in the art. The wrist pin bushing 228 comprises any grade of Vespel® although grade SP21 is preferred, or the wrist pin bushing 228 can comprise polyimides or high strength plastics. Torlon®, or any other polyimide or polyamide plastic or variation of polyimide or polyamide plastic can also be used for the wrist pin bushing 228.

It is noted that the present invention is not limited to cutting cloth, but can be used to cut a plurality of materials, for example it can be used to cut fiberglass matting.

Thus, the crossheads 10, 200, respectively, comprise bearings 8 including ball bearings 20 and bearing components 220 that eliminate the need for a added lubricants. The crossheads 10, 200 have the advantages of decreasing down time, decreasing the need to purchase and store expensive lubricants, decreasing chances that the products/materials being cut will become damaged or ruined by oil, and allow the machine 100 to be tilted in any direction without dripping oil. Thus, the problems associated with the use of lubricants in cutting machines have thus been overcome by the use of bearings 8 as described above.

It will be appreciated by those skilled in the art that while a cutting machine having a crosshead with bearings has been described above in connection with particular embodiments, the invention is not necessarily so limited and other embodiments, examples, uses, and modifications and departures from the embodiments, examples, and uses may be made without departing from the invention. All of these embodiments are intended to be within the scope and spirit of this cutting machine having a crosshead with bearings.

1. A cutting machine comprising:
a) a crosshead having bearings,
b) guides connected to the cutting machine and having recesses sized to receive the bearings therebetween, and
c) a motor in rotational communication with the crosshead and used for reciprocating the crosshead between the guides and the bearings used for allowing reciprocation of the crosshead without the addition of lubricants.

2. A crosshead for use in a cutting machine having guides, the crosshead comprising:
a) a body comprising a first member defining first member pin holes and a second member defining second member pin holes, and a connecting member used for connecting the first member to the second member, the first member and second member defining ball bearing recesses therebetween,
b) ball bearings received in each of the ball bearing recesses,
c) pins positioned through the first pin holes and second pin holes and used for securing the ball bearings in the ball bearing recesses, and
d) the ball bearings positioned in the ball bearing recesses and pinned therein with the pins extending through the ball bearings and pin holes in the first member and the second member and the ball bearings used for rolling over the guides.

3. The crosshead for use in a cutting machine having guides according to claim 2 further wherein the body comprises sides and wherein guide engaging portions of the ball bearings extend past the sides when the ball bearings are pinned in the ball bearing recesses.

4. The crosshead for use in a cutting machine having guides according to claim 2 further comprising a wrist pin housing formed in the body and extending from the body, the wrist pin housing used for receiving a wrist pin therein so that the crosshead can be connected to the cutting machine.

5. The crosshead for use in a cutting machine having guides according to claim 2 wherein the body further comprises a blade side and has a tab extending from the blade side, the tab defining a bolt hole for receiving a bolt so that the cutting machine knife can be bolted thereto.

6. The crosshead for use in a cutting machine having guides according to claim 2 further comprising a slot extending through the first member and the second member and used for receiving the cutting machine knife therein.

7. The crosshead for use in a cutting machine having guides according to claim 2 to wherein the body comprises machined metal or cast metal.

8. The crosshead for use in a cutting machine having guides according to claim 2 further comprising shims connected to the guides and wherein the width of the shims is greater than the width of the guides so that the body wears against the shims as it reciprocates between the guides and the guides are not worn.

9. The crosshead for use in a cutting machine according to claim 3 further comprising shims connected to the guides and wherein the guides have a rolling surface and an extension portion and travel recesses are defined between the shims, rolling surface, and extension portions and the travel recesses are used for allowing the guide engaging portions of the ball bearings to reciprocate back and forth therein.

10. A method of making a crosshead for use in a cutting machine having guides, the method comprising the steps of:
a) providing a body comprising a first member and defining first member pin holes therein and providing a second member and defining second member pin holes therein, and providing a connecting member used for connecting the first member to the second member, the first member and second member defining ball bearing recesses therebetween,
b) providing roller and positioning the ball bearings in each of the ball bearing recesses,
c) providing pins and positioning the pins through the first pin holes and second pin holes and thus securing the ball bearings in the ball bearing recesses, and
d) using the ball bearings for rolling over the guides.

11. The method of making a crosshead for use in a cutting machine according to claim 10 comprising the further steps of providing the body with sides and extending the ball bearings beyond the sides of the body such that guide engaging portions of the ball bearings are provided and which extend past the sides when the ball bearings are pinned in the ball bearing recesses.

12. The method of making a crosshead for use in a cutting machine according to claim 11 comprising the further steps of providing the guides with rolling surfaces and extension portions, and connecting the shims to the guides and defining travel recesses between the shims the rolling surfaces and extension portions and using the travel recesses for allowing the guide engaging portions of the ball bearings to reciprocate back and forth therein, such that the body wears against the shims and not the guides.

13. The method or making a crosshead for use in a cutting machine according to claim 11 comprising the further steps of providing the body with a blade side and providing a tab extending from the blade side, and defining a bolt hole in the tab used for receiving a bolt and bolting the cutting machine knife to the tab.

14. A crosshead for use in a cutting machine, the crosshead comprising:
a) a body having sides and defining bearing component recesses in the sides,
b) a pair of guides each having inwardly sloping walls that meet to define V-shaped recesses,
c) bearing components comprising insertion portions sized to be received in the bearing component recesses defined in the crosshead body,
d) the bearing components connected to the bearing component recesses by an epoxy, and
e) wherein the bearing components further comprise contact sides that are at an angle to one another and are used for being received in the V-shaped recesses defined in the guides.

15. The crosshead according to claim 14 wherein the bearing components comprise a polyimide or a high strength plastic such that the reciprocation of the crosshead by the cutting machine is carried out without added lubricants.

16. The crosshead according to claim 14 wherein the body defines a wrist pin sleeve hole and a wrist pin sleeve is fitted into the wrist pin sleeve hole and a wrist pin bushing is fitted into the wrist pin sleeve and wherein the wrist pin bushing is sized to receive a wrist pin therein.

17. The crosshead according to claim 16 wherein the wrist pin bushing comprises a polyimide or high strength plastic such that the reciprocation of the crosshead is carried out without the use of added lubricants.

18. The crosshead according to claim 14 wherein the guides are adjustable such that as the bearing components wear out the guides are moved toward one by turning adjustment screws the adjustment screws used for extending the working life of the bearing components.

19. The crosshead according to claim 14 wherein the body comprises aluminum or an aluminum alloy.

20. The crosshead according to claim 14 wherein the wrist pin sleeve is oval shaped.

21. A method of making a crosshead for use in a cutting machine, the method comprising the steps of:
a) providing a body having sides and defining bearing component recesses in the sides,
b) providing a pair of guides each having inwardly sloping walls that meet to define V-shaped recesses and connecting the guides to the cutting machine,
c) providing bearing components comprising insertion portions sized to be received in the bearing component recesses defined in the crosshead body,
d) connecting the bearing components to the bearing component recesses by an epoxy, and
e) providing the bearing components with contact sides that are at an angle to one another and positioning the bearing components in the V-shaped recesses defined in the guides.

22. The method of making a crosshead for use in a cutting machine according to claim 21 comprising the further steps of making the bearing components from a polyimide or a high strength plastic and reciprocating the crosshead with the cutting machine without adding lubricants.

23. The method of making a crosshead for use in a cutting machine according to claim 21 comprising the further steps of defining a wrist pin sleeve hole in the body and fitting a wrist pin sleeve into the wrist pin sleeve hole and providing a wrist pin bushing and fitting the wrist pin bushing into the wrist pin sleeve and providing the wrist pin bushing with an opening sized to accommodate a wrist pin therein.

24. The method of making a crosshead for use in a cutting machine according to claim 23 comprising the further step of making the wrist pin bushing from a polyimide or high strength plastic and reciprocating the crosshead without the use of added lubricants.

25. The method of making a crosshead for use in a cutting machine according to claim 21 comprising the steps of providing the inwardly sloping walls of the V-shaped recesses with guide contact surfaces and upon reciprocation of the crosshead by the cutting machine the bearing components slide over the guide contact surfaces.

26. The method of making a crosshead for use in a cutting machine according to claim 21 comprising the further step of providing the bearing components with an arrow shape.
